(19) United States
(12) Patent Application Publication
(10) Pub. No.: US 2019/0299243 A1
(43) Pub. Date: Oct. 3, 2019

(54) FAUX PAINT BRUSH ASSEMBLY

(71) Applicant: MEREDITH GODOI, COLLEYVILLE, TX (US)

(72) Inventor: MEREDITH GODOI, COLLEYVILLE, TX (US)

(21) Appl. No.: 15/941,372

(22) Filed: Mar. 30, 2018

(51) Int. Cl. B05C 17/00; B05C 11/00; B05D 1/28

(52) U.S. Cl. CPC B05C 17/00; B05D 1/28; B05C 11/00

(57) ABSTRACT

A faux paint brush assembly includes a handle and an applicator member. The handle has a handle portion and a base device interchangeably coupled. The applicator member is configured to collect and distribute a particular amount of a liquid medium to a surface in a particular design or pattern. The applicator member is releasably coupled to the base device. The base device is interchangeable to facilitate the use of different applicator members. Each member may be cleaned or discarded separately. The handle portion is configured to facilitate use of an extender member, such as a pole. The applicator member is devoid of bristles and is directly coupled to the handle.

### BACKGROUND

### 1. Field of the Invention

The present application relates to a paint brush tool, and more particularly to an assembly for a paint brush handle.

### 2. Description of Related Art

Paint brushes are well known and are useful in a number of applications. Paint brushes typically include a sturdy handle portion and a set or accumulation of bristles (applicator member) which are secured to the handle. The bristles spread or distribute the liquid (i.e. paint, stain, . . . ). A disadvantage of conventional paint brushes is that it is typically necessary to either clean the paint off of the paint brush, or in the alternative, throw the paint brush away after use.

In an attempt to remedy this problem, steps have been taken to make paint brushes having detachable handles. For example, U.S. Pat. No. 4,471,507 to Schwartz, discloses a paintbrush that allows for the use of a handle with a plurality of ferrules containing fibers. It is also known to use many different means of attaching such tips to such paintbrush handles. For example, U.S. Pat. No. 5,435,037 to Ledingham and U.S. Pat. No. 6,035,481 to Douglas, et al., disclose paintbrushes with different means for attaching bristle packs.

In each of these, a set of bristles are securely attached to a base device which is then inserted into communication with the handle. They are not interchangeable with one another. When the bristles are used up, both the bristles and the base device are discarded because the bristles and base are permanently attached. Various designs have been developed to facilitate attachment of the base to a handle. Typically, the base clips on to the handle in some way. The bristles are generally rigidly fastened in some manner.

Although strides have been made to provide a more flexibility with paint brushes, shortcomings remain. It is desired that an assembly be provided that is configured to permit the interchanging of a handle, base member, and applicator member independent of one another to allow full flexibility and control to the user. This would minimize waste.

### SUMMARY OF THE INVENTION

It is an object of the present application to provide a faux paint brush assembly configured to permit the releasable attachment of an applicator member for the collecting, dispensing and redistribution of a liquid medium on a surface. The liquid medium may be a paint, glaze paint, or stain for example. The faux paint assembly is configured to differ from traditional painting. The faux paint brush assembly permits a technique that creates texture and nuance by replicating the look or feel of other surfaces, such as striped wallpaper, suede or marble. The applicator member is selectively detachable from the handle and can be modified to any particular shape. The assembly includes a handle with a handle portion and a base member. It is an object to provide a user unlimited options for various types of applicator members that can be used in the present assembly.

It is a further object of the present application to provide an assembly that allows for each of the three components to be individually coupled together. In this manner, each may be discarded or cleaned separately. It is another object of the present application to provide a handle that is configured to be adapted for use on an extender member by including an internal port for threaded attachment therewith.

The method of using the assembly is simplified in that a user merely has to select the applicator member to be used to produce the desired results, select a corresponding base device and attach the two together. Once coupled, the base device is coupled to the handle. Extender member may be added to facilitate ease of use for the user. Once completed, any of the three components may be selectively detached and either cleaned for use again or discarded. Ultimately the invention may take many embodiments. In these ways, this assembly overcomes the disadvantages inherent in the prior art.

The more important features of the assembly have thus been outlined in order that the more detailed description that follows may be better understood and to ensure that the present contribution to the art is appreciated. Additional features of the assembly will be described hereinafter and will form the subject matter of the claims that follow.

Many objects of the present assembly will appear from the following description and appended claims, reference being made to the accompanying drawings forming a part of this specification wherein like reference characters designate corresponding parts in the several views.

Before explaining at least one embodiment of the assembly in detail, it is to be understood that the assembly is not limited in its application to the details of construction and the arrangements of the components set forth in the following description or illustrated in the drawings. The assembly is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present assembly. It is important, therefore, that the claims be regarded as including such equivalent constructions insofar as they do not depart from the spirit and scope of the present assembly.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is an exploded perspective view of a faux paint brush assembly according to an embodiment of the present application.

FIG. 2 is a side view of a handle member used in faux paint brush assembly of FIG. 1.

FIG. 3 is a top view of the handle member of FIG. 2.

FIG. 4 is a section view of the handle member of FIG. 2.

FIG. 5 is a side view of a plug in the faux paint brush assembly of FIG. 1.

FIG. 6 is a side view of a base device in the faux paint brush assembly of FIG. 1.

FIG. 7 is a top view of the base device of FIG. 6.

FIG. 8 is a section view of the base device of FIG. 6.

FIG. 9 is a side view of an applicator member in the faux paint brush assembly of FIG. 1.

FIG. 10 is a chart of the process of operating the faux paint brush assembly of FIG. 1.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the assembly described herein may be oriented in any desired direction.

The assembly and method in accordance with the present application overcomes one or more of the above-discussed problems commonly associated with conventional paint brush designs. In particular, the faux paint brush assembly of the present application is configured to minimize waste and provide flexibility to the user to select the particular applicator member for use. The assembly is configured to be selectively separable wherein each member is detachable from the other members. This allows ease of cleaning and minimal waste. Additionally, each member may be selected in accordance with the desired result to provide increased flexibility. The assembly is not locked into using only bristles that are rigidly coupled to a base where cleaning is still difficult to do. Rather an applicator is devoid of bristles to allow for the generation of the texture and nuance found with faux painting. Additionally, the assembly allows for different styles of design by selection of different applicator members. These and other unique features of the assembly are discussed below and illustrated in the accompanying drawings.

The assembly and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The assembly and method of the present application is illustrated in the associated drawings. The faux paint brush assembly includes a handle that has a handle portion and a base device interchangeably coupled. Also included is an applicator member configured to apply a particular amount of liquid medium to a surface in a particular design or pattern. The applicator member is ideally releasably coupled to the base device. The base device is interchangeable to facilitate the use of different applicator members. Each member may be cleaned or discarded separately. The handle portion is configured to facilitate use of an extender member, such as a pole. Additional features and functions of the device are illustrated and discussed below.

Referring now to the Figures wherein like reference characters identify corresponding or similar elements in form and function throughout the several views. The following Figures describe the assembly of the present application and its associated features. With reference now to the Figures, an embodiment of the modular observation assembly and method of use are herein described. It should be noted that the articles “a”, “an”, and “the”, as used in this specification, include plural referents unless the content clearly dictates otherwise.

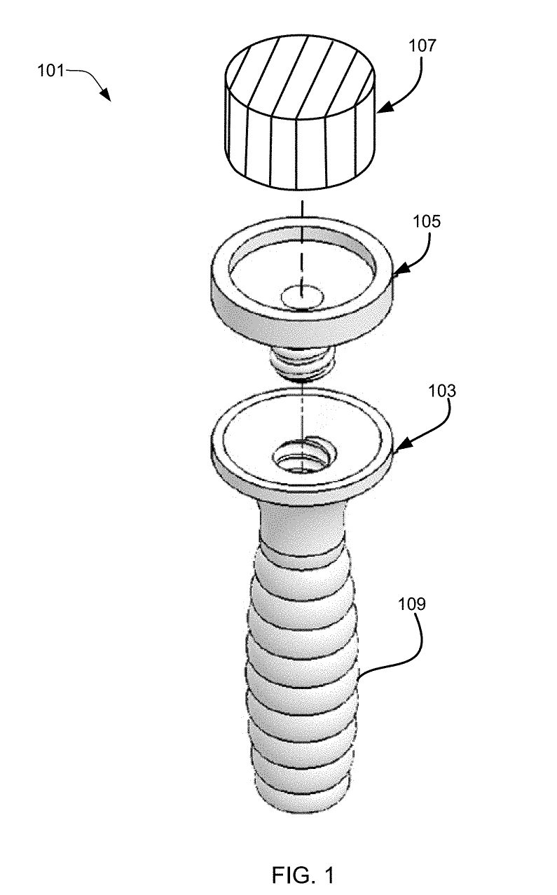

Referring now to FIG. 1 in the drawings, a perspective view of a faux paint brush assembly 101 is illustrated. Assembly 101 is configured to permit increased flexibility in painting by allowing the user to select the type of applicator member used. Choice in the applicator member allows the user to select the style and design of the paint as applied to a surface. It is understood that assembly 101 will be described with respect to painting with a liquid medium being paint. Other forms of liquid mediums are possible, such as glaze paint and stain for example. Use of assembly 101 is designed to facilitate the at least one of the capture and transfer of a liquid medium to a surface followed by a subsequent redistribution, and redistribution only of the liquid medium on a surface. Exemplary surfaces may be a wall or ceiling.

Assembly 101 includes a handle portion 103, a base device 105, and an applicator member 107. In FIG. 1, assembly 101 is shown in an exploded view to see the three main parts. Each part is releasably coupled to its neighboring part. Member 107 attaches to base device 105 and base device 105 attaches to handle portion 103. In some embodiments, member 107 may be unreleasably secured to base device 105.

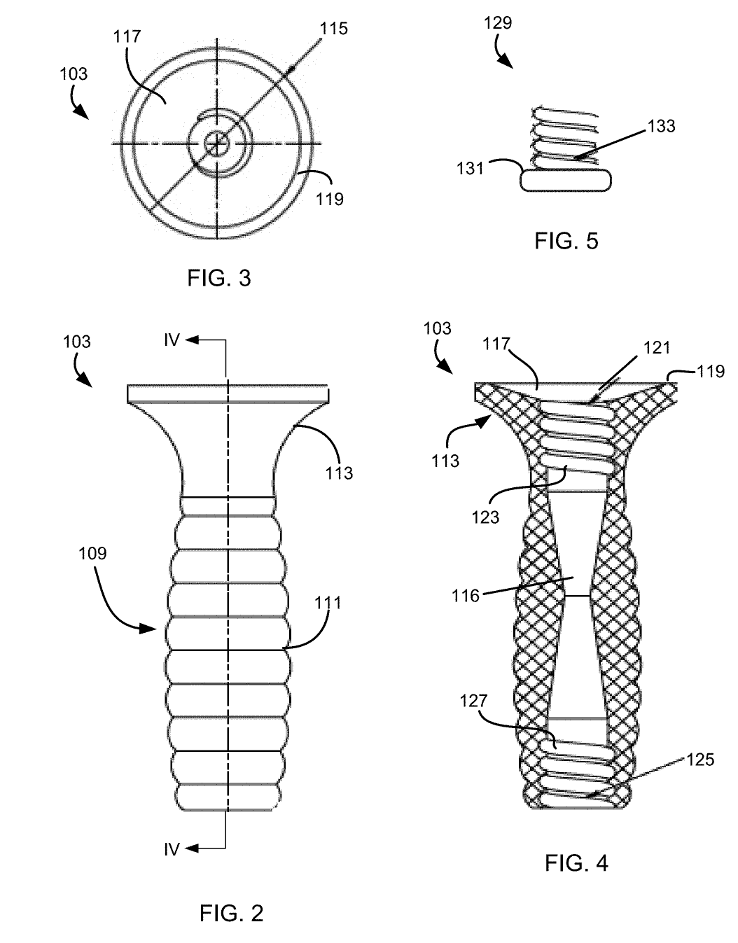

Referring now also to FIGS. 2-4 in the drawings, various views of handle portion 103 are illustrated. Handle portion 103 is configured to include an ergonomic gripping surface 109. Such surface may include one or more grooves 111 and may also include various forms of texture to increase comfort and grip. Handle portion 103 includes a flared end 113 configured to have a larger diameter 115 than surface 109.

In FIG. 3, a top view of handle portion 103 is provided. Flared end 113 is configured to have an inner surface 117 that extends across a portion of diameter 115. Flared end 113 has a rim 119 around the periphery and is configured to help define the bounds of surface 117. As seen in FIG. 4, handle portion 103 is hollow. An upper opening 121 is centrally located within surface 117 and is configured to include one or more fasteners 123. An example of a fastener may be a magnet or internal female threads. Similarly, a second opening 125 is formed in handle portion 103 and is opposite that of surface 117. It too is centrally located and includes a fastener 127 similar in form and function to those describe with fastener 123. The hollowed passage 116 within handle portion 103 extends between openings 121 and 125, such that each is concentric with the other.

It is worth noting that the particular shape or contours of flared end 113, surface 117 and diameter 115 are not limiting to that which is shown. The contours and shapes may vary depending on design constraints.

Referring now also to FIG. 5 in the drawings, a plug 129 is optionally included within assembly 101. Plug 129 includes a cap 131 and a connector 133. Connector 133 is configured to be releasably inserted into hollow passage 116 and engage an internal surface of fastener 127. Connector 133 may be any type of fastener and should be suitable for use with fastener 127. Therefore an example would be external male threads (as depicted) or a corresponding magnet for example. Plug 129 is configured to close opening 125. Cap 131 remains external to handle portion 103 and contacts a lower surface of handle portion 103 at the base of grip 109.

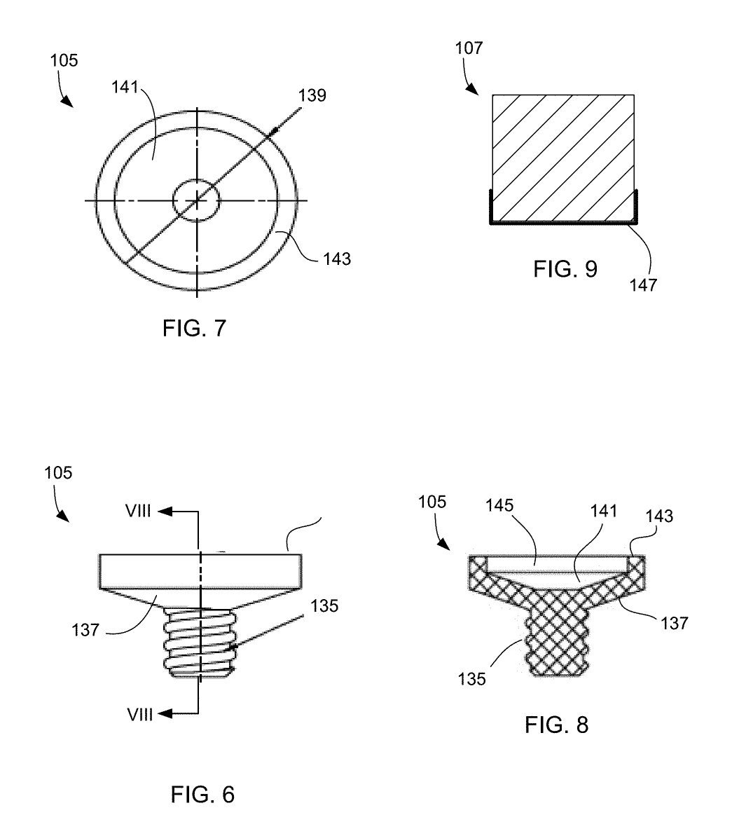

Referring now also to FIGS. 6-8 in the drawings, various views of base device 105 are illustrated. Base device 105 is configured to releasably couple to handle portion 103. The combined coupling of device 105 and portion 103 forms a full and complete handle. It is understood that base device 105 does not have to be used, wherein handle portion 103 is suitable on its own to facilitate grabbing by a user; however, to facilitate the full extent of assembly 101, base device should be used.

Base device 105 includes a connector 135 similar in form and function to connector 133. In FIG. 6, connector 135 is depicted as having external male threads. Connector 135 is configured to engage opening 121 and fastener 123. Base device 105 includes a flared end 137 configure to have a similar diameter 139 as flared end 113. Base end 105 includes an internal surface 141 and a rim 143. Rim 143 is raised above surface 141. Also of note is that surface 141 is concaved such that the center of surface 141 is recessed below the outer portions of surface 141 along rim 143. The recessed contour is partially facilitated by the flared end shape of end 137. In use, flared end 137 is configured to seat within and make contact with surface 117. When contacted, flared end 137 contacts rim 119 around the periphery to prevent seepage of the liquid medium there between. It is not necessary that flared end 137 be contoured exactly to the profile of surface 117 as long as contact around the periphery occurs. Any seepage of liquid medium from applicator member 107 will collect in surface 141.

Referring now also to FIG. 9 in the drawings, applicator member 107 is illustrated. Applicator member 107 is configured to be secured to base device 105. In so doing, applicator member 107 may be non-releasable or may be releasable therefrom. Ideally a releasable coupling has the advantage wherein applicator member 107 can be interchanged and base device 105 is reusable with different types of applicator members 107.

Applicator member 107 is configured to contact at least one of surface 141 and rim 143. Applicator member 107 may also contact inner rim surface 145. Applicator member 107 may be adhered to a portion of surface 143 and/or surface 145. It is understood that the adhering may be facilitated through an adhesive 147 applied to any suitable corresponding surface of applicator member 107. The adhesive may be permanent or may be releasable to facilitate interchanging of applicator member 107. Other methods or forms of attachment are considered, such as hook and loop fasteners, clamps, and compression fit.

The type of applicator member 105 used may influence the design, pattern of distribution, and function in the painting process. In faux painting, one manner of use is to pre-apply the liquid medium to a surface and then use applicator member 107 to redistribute the liquid member in a patterned order. In another manner of faux painting, applicator member 107 may be used to capture and apply a portion of the liquid member to the surface followed by a subsequent orderly redistribution.

Applicator member 107 may be made from any number of materials, wherein the type of material can greatly affect the design and manner of application. For example, member 107 may be a sponge wherein a portion of the liquid medium is absorbed. The liquid medium would be distributed to the surface when the applicator member is compressed. In another embodiment, applicator member 107 may be a crumpled plastic bag wherein member 107 would be ideally used from redistribution of the liquid member along the surface as opposed to the primary method of applying the liquid medium to the surface as well.

It is noted that applicator member 107 is configured to provide a faux painting design different from traditional bristles used with customary brushes. Therefore, it is preferred that applicator member 107 is devoid of bristles or their equivalent as its purpose and function is different from that of traditional painting. Additionally, although plastic and a sponge are examples provided of member 107, it is understood that member 107 may be any material such as a composite, leather, mesh or so forth. Material selection has an influence on the design pattern of member 107. The particular shape of applicator member 107 in the Figures is merely exemplary in nature. An unlimited number of shapes and sizes may be used which can ultimately be affected by the type of material selected.

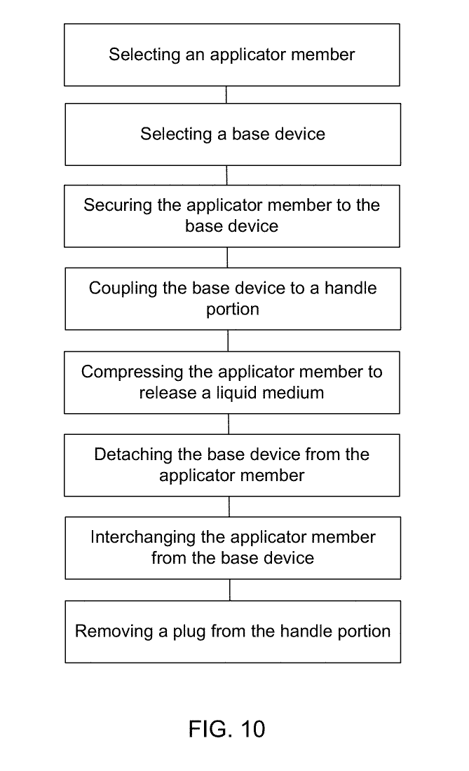

Referring now also to FIG. 10 in the drawings, a chart of using assembly 101 is illustrated. In use, a user selects the applicator member that will provide the desired result. The base device is then selected that conforms to the shape of the applicator member. By having the base device detachable from the handle portion as well, the base device allows for a singular handle portion to be used with any shaped or type of applicator member. When applicator member is interchanged, only the base device may need to be changed; wherein the handle portion is suitable for any applicator member. The applicator member is secured to a surface of the base device. The base device is secured to the handle portion. A user then manipulates the handle portion to allow collection and distribution of the liquid medium via the applicator member. Distribution may occur via compressing the applicator member. At any time, the applicator member may be detached and interchanged on the base device. Additionally, the base device may then also be interchanged on the handle portion. The plug may be removed (where equipped) to allow an extender member to engage fasteners 127. The extender member is configured to assist in increasing the reach of the user. It may be a traditional extension pole used in painting.

The current application has many advantages over the prior art including at least the following: (1) the applicator member is individually attached to the handle to ease cleaning and minimize waste; (2) the applicator member is configured to provide a faux painting finish; (3) the base device permits the handle portion to operate with any applicator member; (4) the applicator member is coupled via a releasable adhesive; and (5) minimized waste.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A paint brush assembly, comprising:
a handle portion configured to include an ergonomic grip for a user;
a base device releasably coupled to the handle portion, the handle portion and the base device forming a handle; and
an applicator member releasably coupled to the base device and configured to transfer a liquid medium to a surface.

2. The assembly of claim 1, wherein the applicator member is a sponge.

3. The assembly of claim 1, wherein the applicator member is configured to absorb the liquid medium.

4. The assembly of claim 1, wherein the applicator member is devoid of bristles.

5. The assembly of claim 1, wherein the handle portion is hollowed.

6. The assembly of claim 1, wherein the handle portion includes internal threads.

7. The assembly of claim 1, further comprising:
a plug releasably coupled to a portion of the handle portion.

8. The assembly of claim 7, wherein the plug is threadedly coupled to an internal surface of the handle portion.

9. The assembly of claim 1, wherein the base device is configured to seat against a first surface of the handle portion.

10. The assembly of claim 1, wherein the base device and the handle portion make contact around the periphery of the base device to prevent seepage internally to the handle portion.

11. The assembly of claim 1, wherein the applicator member is adhered to the base device with an adhesive.

12. A method of using a paint brush, comprising:
selecting an applicator member configured to position a liquid medium on a surface;
selecting a base device based on the shape of the applicator member, the base device configured to support the applicator member;
securing the applicator member to a surface of the base device; and
coupling the base device to a handle portion;
wherein the applicator member is fully detachable from the base device and the handle portion.

13. The method of claim 12, wherein the applicator member is a sponge.

14. The method of claim 12, wherein the applicator member is configured to absorb the liquid medium.

15. The method of claim 12, wherein the applicator member is configured to transfer the liquid medium to the surface when compressed.

16. The method of claim 12, further comprising:
compressing the applicator member against the surface to release the liquid medium.

17. The method of claim 12, further comprising:
detaching the base device and the applicator member.

18. The method of claim 12, further comprising:
interchanging the applicator member from the base device.

19. The method of claim 12, further comprising:
removing a plug from the handle portion.
